(19) United States
(12) Patent Application Publication
(10) Pub. No.: US 2004/0244814 A1
(43) Pub. Date: Dec. 9, 2004

(54) Dental flossers

(76) Inventor: Frank Joseph Prineppi, Grand Bahama (BS)

Correspondence Address: Jay A. Bondell, Esq., SCHWEITZER CORNMAN GROSS & BONDELL LLP, 19th Floor, 292 Madison Avenue, New York, NY, 10017, US

(21) Appl. No.: 10/879,302

(22) Filed: Jun. 29, 2004

Related U.S. Application Data
(63) Continuation-in-part of application No. 10/829,045, filed on Apr. 21, 2004.

(30) Foreign Application Priority Data
Jun. 5, 2003 (GB) 0312872.5
Jul. 3, 2003 (GB) 0315555.3

(51) Int. Cl. A61C 15/00

(52) U.S. Cl. 132/322; 132/325; 132/326

(57) ABSTRACT

The present invention provides in a first aspect a dental flosser attachment for a toothbrush driver in which dental floss from a spool on or in the attachment is fed via a floss quick release locking mechanism to a floss receiving end of one of a pair of prongs extending from the body of the attachment to a floss receiving end of the other prong and back to the quick release mechanism such that the free end of the floss may be pulled to tension the floss between the prongs, whereafter the quick release mechanism is releasably locked to retain the tension of the floss therebetween, including across the prongs, the quick release mechanism being mounted for reciprocable rotation relative to the prongs to thereby cause the floss to oscillate therebetween when the flosser attachment is activated by the toothbrush driver.

This application is a continuation-in-part of U.S. patent application Ser. No. 10/829,045, filed Apr. 21, 2004.

This invention relates to dental flossers and more particularly to electrically powered dental flossers which reciprocate a length of floss for cleaning inbetween teeth and over gums.

### BACKGROUND OF THE INVENTION

Dental flossers are known which include a bow for supporting a short length of floss and an electrically powered version of this is shown in U.S. Pat. No. 5,762,078 in which a flosser head for a toothbrush driver incorporates a mechanism for reciprocating the flosser bow linearly with respect to the major axis of the toothbrush driver. However, it has been found that a preferred configuration is for the floss to be stretched over a pair of prongs for reciprocation laterally with respect to the major axis of the toothbrush driver and a number of arrangements have been proposed, such as that shown in U.S. Pat. No. 5,085,236 where a dental flossing attachment adapted to be mounted on a drive shaft of an electric toothbrush driver incorporates a floss supply spool and a floss take-up spool at the base of the prongs in the attachment. This obviates the need for threading of the floss every time new floss is required, through the use of a floss advancing mechanism, the entire arrangement being disposable so that when fresh dental floss is exhausted the dental flossing attachment is removed and discarded, with a new attachment then being snapped into place on the toothbrush driver as desired.

### SUMMARY OF THE INVENTION

The present invention provides in a first aspect a dental flosser attachment for a toothbrush driver in which dental floss from a spool on or in the attachment is fed via a floss quick release locking mechanism to a floss receiving end of one of a pair of prongs extending from the body of the attachment to a floss receiving end of the other prong and back to the quick release mechanism such that the free end of the floss may be pulled to tension the floss between the prongs, whereafter the quick release mechanism is releasably locked to retain the tension of the floss therebetween, including across the prongs, the quick release mechanism being mounted for reciprocable rotation relative to the prongs to thereby cause the floss to oscillate therebetween when the flosser attachment is activated by the toothbrush driver.

Preferably, the dental flosser attachment is driven by a motor via a drive train in which circular motion is translated into oscillating or reciprocating movement, such as by the use of a bell-crank mechanism or a crown gear and associated spur gear, to which crown gear is eccentrically mounted a drive pin attached to one end of a drive link, the other end of which is attached to the quick release mechanism and/or a platform on which a quick release mechanism is mounted.

Conveniently, the quick release mechanism may itself comprise a pair of fixed clamp jaws, against each of which a pair of slideable clamp jaws are engageable to trap respective parts of a length of floss therebetween, the intermediate length of floss being at least partially supported by the prongs of the flosser attachment to enable flossing by a user of the combination flosser attachment and toothbrush driver. Preferably, the slideably mounted damp jaws have cam surfaces co-operable with projections on or in a rotatable knob adjacent thereto such that upon partial rotation of the knob in one direction the slideable jaws are forced apart so as to engage with the fixed clamp jaws or floss therebetween. Conveniently, the slideable clamp jaws are biased to their open position by means of a spring arm which may conveniently be made of nylon. The spring arm may comprise two springs, one for each slideable clamp jaw, and may further be integrally formed with a centrally disposed collar relative to the rotational axis of the knob.

In an alternative embodiment, the slideably mounted clamp jaws may be forced to their closure position against the fixed clamp jaws by means of an over-center cam locking arrangement including a rotatable drive plate having diagonally opposite cam surfaces which engage innermost surfaces of the slideable clamp jaws such that upon rotation of the drive shaft in one direction the jaws are forced apart to engage with the fixed clamp jaws or floss therebetween. Conveniently, drive links are attached to the drive plate to provide an over-center cam locking arrangement whereby the slideable clamp jaws are retained in their locked position when the drive plate is rotated slightly beyond the point by which the slideable clamp jaws are in their initially locked positions, such that upon rotation of the drive plate in the opposite direction the slideable jaws become unlocked and can be returned to their original open position.

In a further alternative embodiment, the quick release mechanism may be in the form of a slotted disc in which a pair of symmetrically disposed spiral slots act as cam surfaces co-operable with projections, such as drive pins, attached to the slideable clamp jaws, either directly or indirectly, such that upon rotation of the slotted disc the slideable jaws are forced to move from an open to a closed position relative to the fixed jaws and vice versa.

In accordance with a second aspect of the invention there is provided an electrically powered flosser comprising a body portion, a head portion from which extend a pair of prongs for receiving floss therebetween, the head portion including a quick release mechanism for releasably locking a length of floss between the prongs of the flosser, the quick release mechanism being mounted for reciprocable movement such that floss between the prongs oscillates on movement of the quick release mechanism when locked, the quick release mechanism being drivingly connected to a motor in the body portion.

### BRIEF DESCRIPTION OF THE DRAWINGS

The invention will now be described, by way of example only, with reference to the accompanying drawings in which:

FIG. 1 is a front perspective view of a dental flosser attachment for a toothbrush driver showing the quick release mechanism in its open, unlocked, position;

FIG. 2 is a view corresponding to that of FIG. 1 showing the quick release mechanism in its closed, locked, position;

FIG. 3 is a perspective view of the attachment of FIG. 1 from the front and other side showing part of the locking button assembly removed,

FIG. 4 is a top view to that shown in FIG. 3, showing part of the quick release mechanism exposed;

FIG. 5 is an underneath view of part of the locking mechanism;

FIG. 6 is a perspective view showing the drive train from an electric motor (not shown) to the quick release mechanism,

FIG. 7 is a top plan view of the arrangement of FIG. 6 with part of the locking mechanism removed;

FIG. 8a is a plan view of an alternative quick release mechanism shown in its unlocked position;

FIG. 8b is a schematic plan view of the quick release mechanism of FIG. 8a in its over-center locked position;

FIG. 9a is an exploded sectional elevation of the quick release mechanism of FIG. 8a along the line x-x;

FIG. 9b is a sectional elevation along the line y-y of part of the quick release mechanism of FIG. 9a;

FIG. 10 is a plan view of a further alternative quick release mechanism using a cam locking mechanism;

FIG. 11 is a perspective view of a still further alternative quick release mechanism using an alternative cam locking mechanism to that shown in FIG. 10;

FIG. 12 is a view corresponding to part of the arrangement shown in FIG. 11 but with the rotatable actuation knob shown removed; and

FIG. 13 is an underneath plan view of the rotatable knob shown in FIG. 11.

### DETAILED DESCRIPTION OF THE DRAWINGS

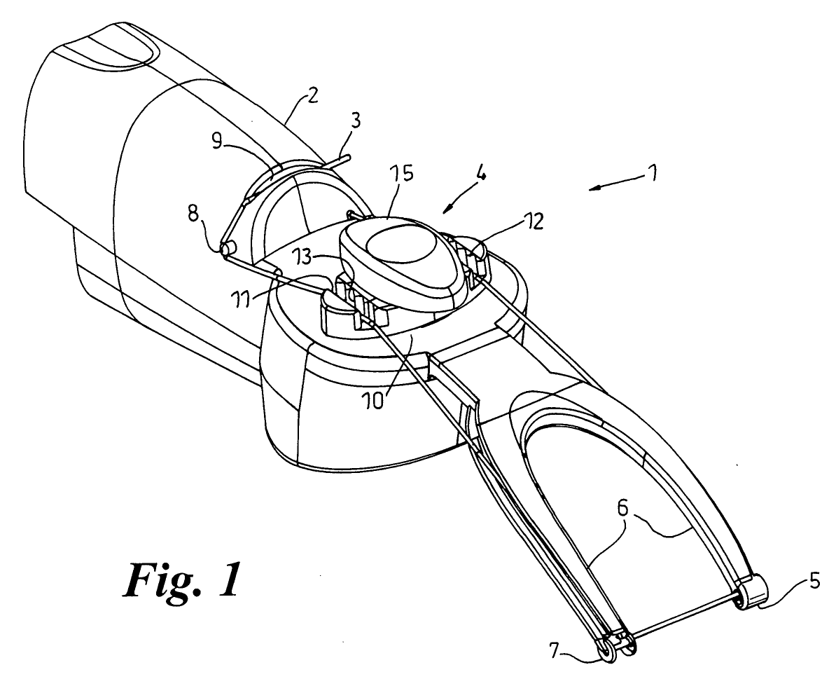

Referring firstly to FIGS. 1 to 5, a flosser head attachment shown generally at 1 includes a body portion 2 for fitting to the end of an electrically operated toothbrush driver (not shown) in place of a toothbrush attachment, the body portion 2 containing a spool of dental floss (not shown), from which spool of floss extends a continuous line of floss 3, initially through a quick release mechanism shown generally at 4 to a floss receiving end 5 of one of a pair of prongs 6 and then via a floss receiving end 7 of the other prong back to the quick release mechanism 4, around a peg 8 extending from the body portion 2 and thereafter into a notch 9 in the body portion 2, which notch includes at the base thereof a blade (not shown) for cutting used lengths of floss 3 as required.

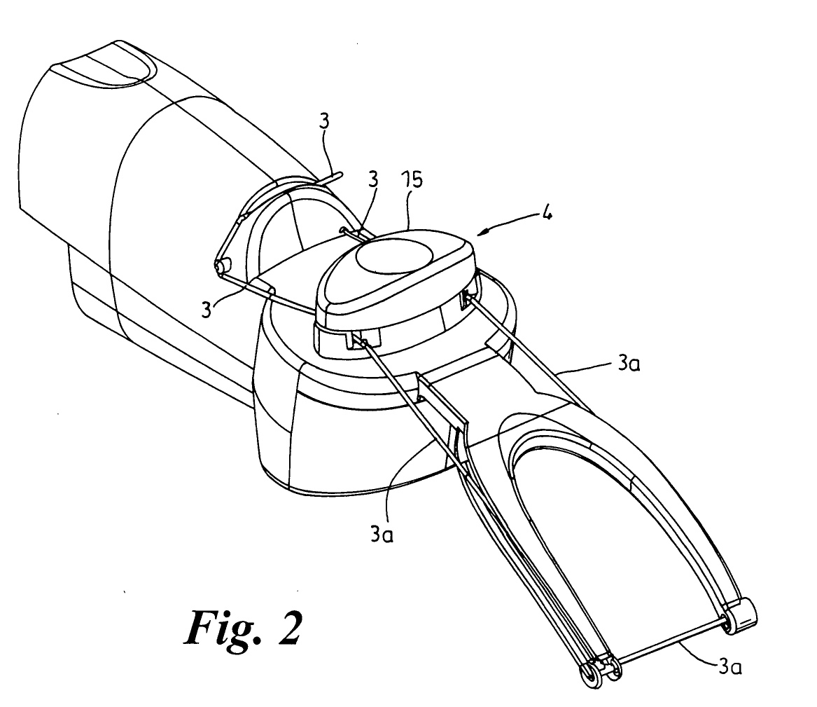

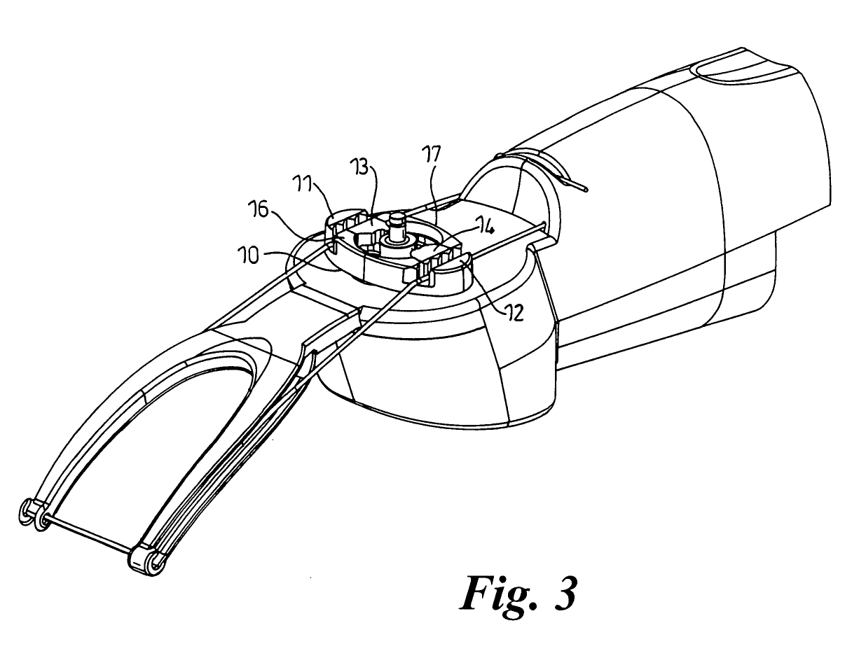

The quick release mechanism 4 comprises an elliptical pivotally mounted clamp platform 10 having fixed clamp jaws 1 1, 12 at respective ends thereof, against which oppositely disposed slideably mounted clamp jaws 13, 14 (best seen with reference to FIGS. 3 to 5) can bear to releasably capture or lock the line of floss 3 when a rotatable button or knob 15 is rotated to the position shown in FIG. 2, in which position the length of floss 3a trapped between the clamp jaws 11, 13 and 12, 14 prevent further linear movement of the floss 3a relative to the quick release mechanism 4.

The outer sides of the prongs 6 are channel shaped such that when the prongs 6 are placed into the mouth of a user of the device respectively opposite portions of the length of floss 3a do not rub against the inside of the mouth of the user in these regions.

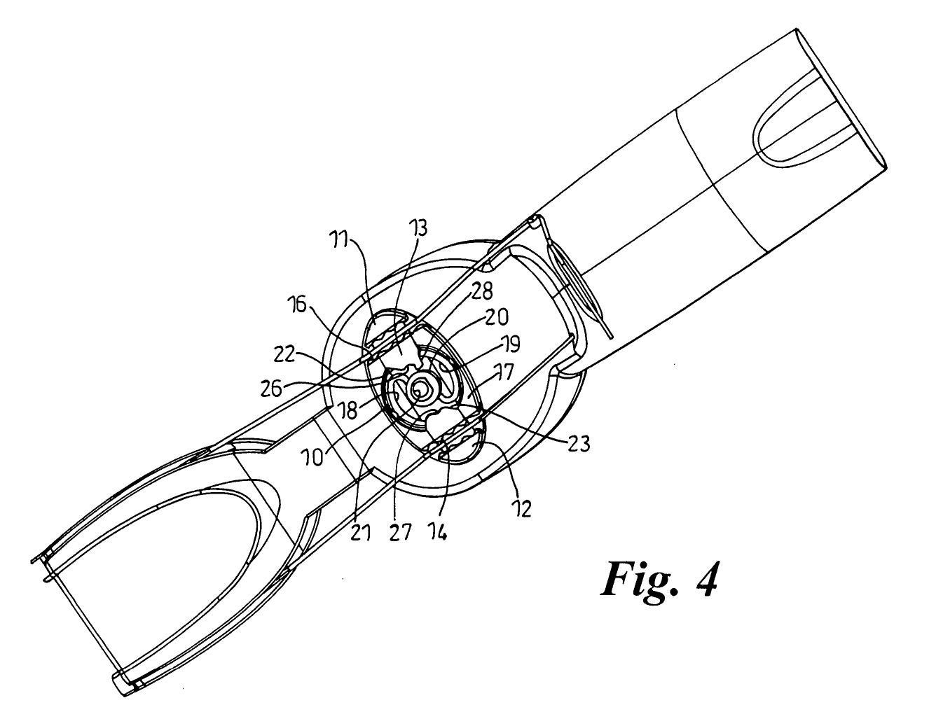

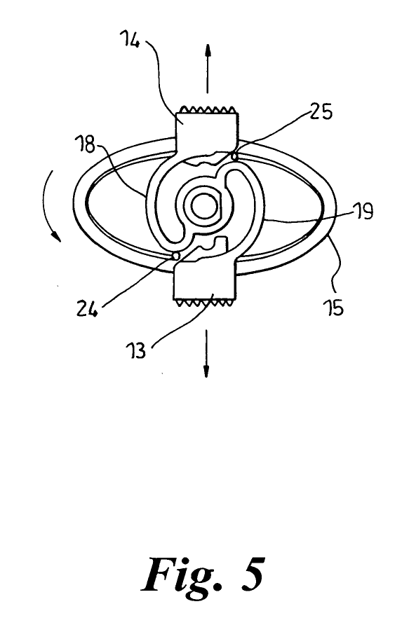

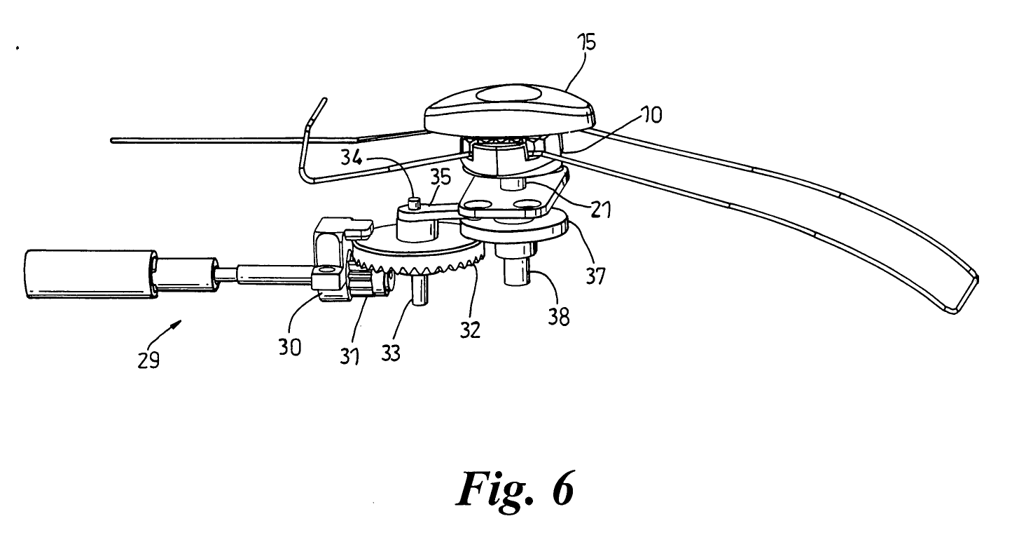

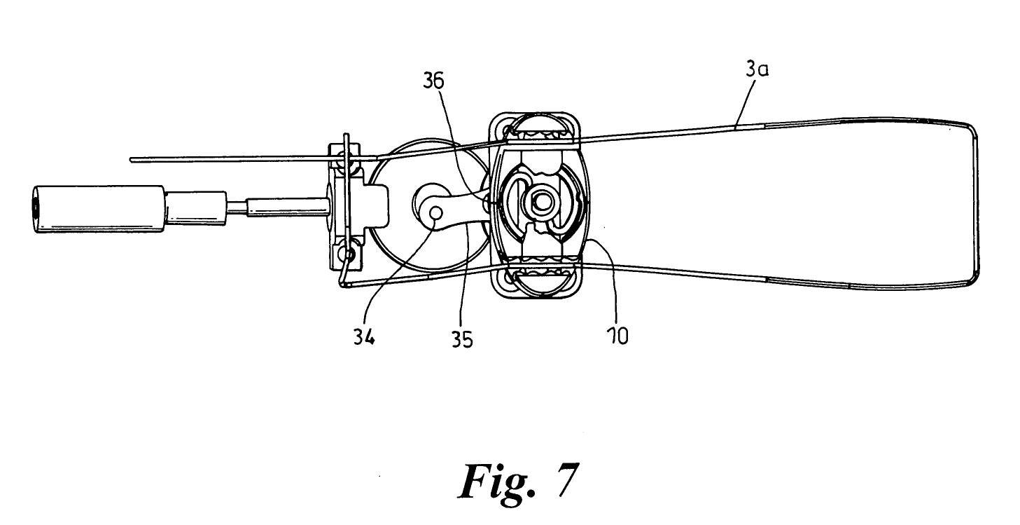

FIGS. 3 to 5 collectively show how the quick release mechanism for the floss 3 works. In FIGS. 3 and 4 the knob 15 has been removed to reveal the slideably mounted clamp jaws 13, 14 disposed between the fixed clamp jaws 11, 12 on the moveably mounted platform 10. The slideably mounted clamp jaws 13, 14 are received between respective side walls 16, 17 of the platform 10 and each is connected to the other via a pair of resiliently deformable arcuate spring arms 18, 19 integral with and extending outwardly from a central collar 20 keyed to a centrally disposed drive shaft 21 to which the platform 10 is also drivingly secured in a manner to be explained with reference to FIGS. 6 and 7. Each of the slideable clamp jaws 13, 14 have respective cam surfaces 22, 23 by which a pair of diagonally opposite pins 24, 25 (shown in FIG. 5) on the underside of and protruding from the knob 15 can force the slideable clamp jaws 13, 14 outwardly towards the fixed clamp jaws 11, 12 when the knob 15 is rotated to the position shown in FIG. 2, whereafter the pins 24, 25 then rest in respective detents 26, 27 to releasably lock the floss 3 against linear movement until the knob 15 is returned to the position shown in FIG. 1. A stop member 28 is provided on slideable clamp member 13 to prevent the knob 15 from being rotated too far.

FIG. 5 is an underside view of the knob 15, slideable clamp jaws 13, 14 and associated spring arms 18, 19 and collar 20, from which it will be apparent 15 that upon rotation of the knob 15 and hence pins 24, 25 in the anticlockwise directionarrowed, the pins-rise up the-cam surfaces 22, 23 on the slideably mounted clamp jaws 13, 14 to force them apart in opposite directions, as arrowed, the spring arms 18, 19 providing for their return to the position shown when the knob 15 is returned also to the position shown.

In FIGS. 6 and 7 there are shown respective views of the drive train from a motor (not shown) to the moveably mounted platform 10, shown in FIG. 6 with the knob 15 in place and in FIG. 7 without it in place. A drive shaft assembly shown generally at 29 is secured to the inside of the body portion 2 (not shown) by a bushing 30 and ends with a spur gear 31 secured to the end thereof for rotation therewith. The spur gear 31 meshes with a crown gear 32 mounted on a spindle 33 so that rotation about the major axis of the drive shaft assembly 29 is converted into rotation about the major axis of the spindle 33.

Extending from the upper end of the crown gear 32 is an eccentrically projecting drive pin 34 (seen more clearly with reference to FIG. 7) to which is attached a drive link 35, the other end of which is secured to a secondary drive pin 36 extending from an edge region of a drive plate 37 fixed for rotation about a shaft 38 and connected, in turn, to the drive shaft 21 shown in FIG. 4, which itself is fixed for rotation with the moveably mounted platform 10. Accordingly, 10 upon rotation of the spur gear 31 in either direction, and by virtue of the eccentrically mounted pin 34 and link 35, purely rotational movement of crown gear 32 is translated into an oscillating movement of drive plate 37 and hence, via drive shaft 21, the moveably mounted platform 10, which therefore twists back and forth about the axis of the drive shaft 21. In doing so, floss 3a trapped between the clamp jaws 11, 13 and 12, 14 when the quick release clamp mechanism is in its locked position, as shown in FIG. 2, is pulled back-and forth over the prongs 6 in consecutively opposite directions so that that portion of floss 3a between the prongs 6 can therefore provide for automatic flossing between teeth and over gums.

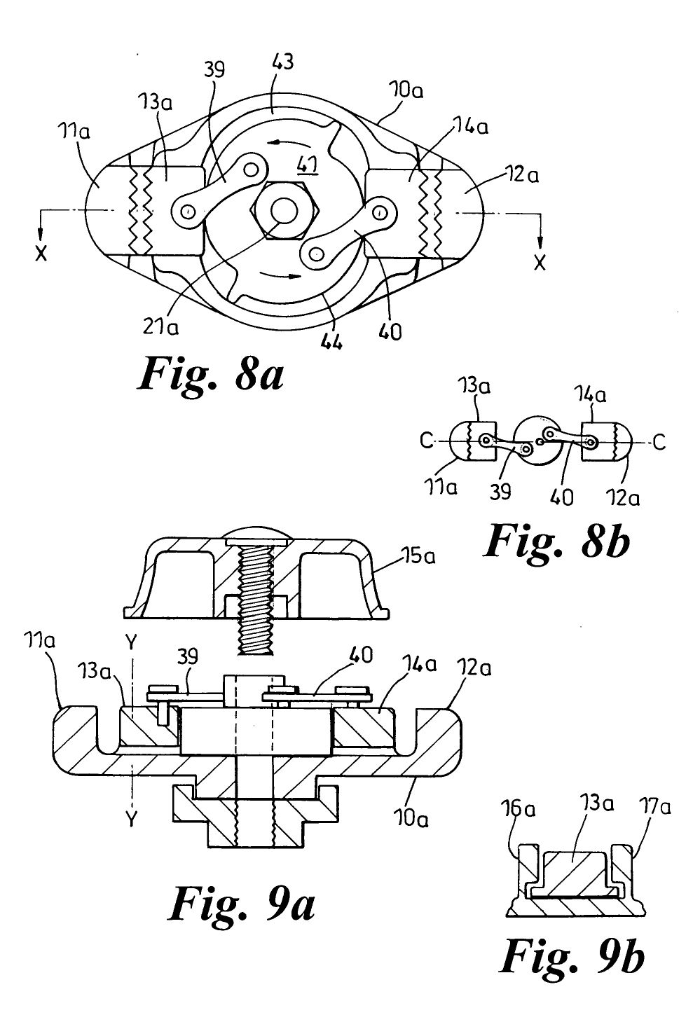

Although the embodiment shown with reference to FIGS. 1 to 7 is adapted to be attached to a toothbrush driver, typically comprising a battery powered electric motor and associated drive train assembly, nevertheless it will be appreciated that such, and those to be described in FIGS. 8 to 10, may be incorporated integrally with the flosser attachment, in accordance with a second aspect of the invention.

As will be apparent from, particularly, FIG. 4, when the clamp platform 10 and associated clamp jaws 11, 13 and 12, 14 oscillate about the axis of the drive shaft 21 the length of floss 3a trapped therebetween immediately adjacent the clamp platform 10 oscillates to a corresponding degree. Although in the embodiment described the positioning of the platform 10 about the axis of the drive shaft 21 is perfectly symmetrical, in alternative embodiments of the invention the platform 10 may instead be positioned further forward or further back relative to the major axis of the flosser attachment to thereby vary the amount of oscillation of the floss 3a in this region.

In a further refinement, slideable clamp jaw 14 may be dimensioned to cause it to engage with fixed clamp jaw 12 just before slideable clamp jaw 13 engages with fixed clamp jaw 11 such that the captured length of floss 3a is provided with a degree of tension prior to the slideable jaw clamp 13 engaging with the fixed jaw clamp 11. In an alternative embodiment, the spool of floss may be provided with a clutch mechanism to provide resistance to rotation as floss is pulled from it, thereby inherently providing a degree of tension in the captured length of floss 3a.

Where the flosser attachment or electrically powered flosser, as the case may be, is not intended to be a disposable item such that replacement spools of floss may be provided, an openable cover may be provided to allow for insertion and removal of the spool as required.

Turning now to FIGS. 8a, 8b and 9a, 9b, there is shown an alternative quick release mechanism utilizing an over-center cam locking arrangement. A clamp platform 10a is again provided with fixed clamp jaws 11a, 12a and slideable clamp jaws 13a, 14a, the latter pair of clamp jaws being linked via drive links 39, 40 to a clamp actuation plate 41 fixed for rotation about, but not with, drive shaft 21a. The plate 41 has diagonally opposite cam surfaces 43, 44 which engage the innermost surfaces of the slideable clamp jaws 13a, 14a, such that when the plate 41 is rotated anticlockwise in the direction arrowed by turning the knob 15a, to which it is secured for rotation therewith, the moveable clamp jaws 13a, 14a engage the fixed clamp jaws 11a, 12a and as the knob 15a continues to rotate the links 39, 40 assume the over-center position past center-line c-c shown in FIG. 8b, in which position dental floss (not shown) is releasably secured between the clamp jaws 11a, 13a and 12a, 14a.

As shown in FIG. 9b, being a part section along the line y-y of FIG. 9a, the slideable clamp jaw 13a is retained in position between the side walls 16a, 17a by being flanged at its lower end so as to be retained within corresponding recesses in the lower ends of the side walls 16a, 17a and, likewise, slideable clamp jaw 14a is also retained in the same manner on the opposite side of the moveably mounted platform 10a.

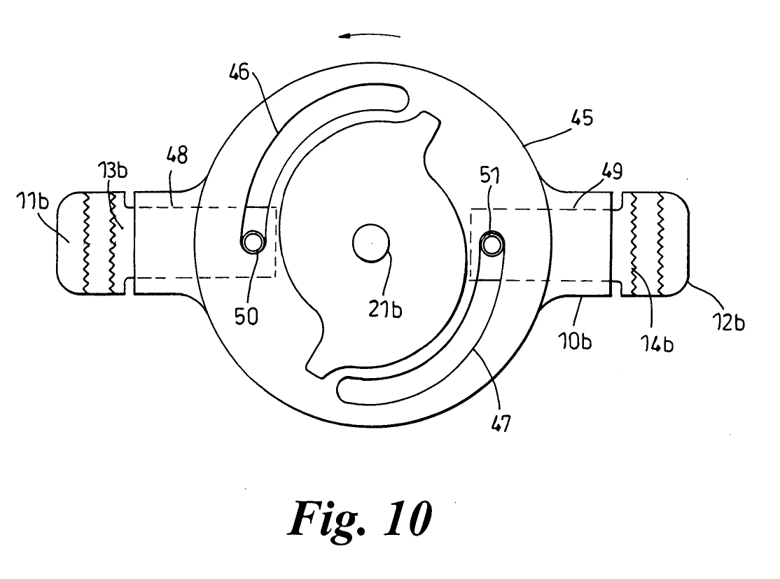

A further embodiment of the invention is shown schematically in FIG. 10 where a different mechanism is used to move the slideable clamp jaws 13b, 14b into and out of engagement with the fixed clamp jaws 11b, 12b. In this arrangement a slotted clamp actuation disc 45 is mounted for rotation on the platform 10b, the slots 46, 47 each spiraling gently outwards from the central axis of the drive shaft 21b. The moveable clamp jaws 13b and 14b in this embodiment are each connected to respective clamp plunger rods 48, 49 (shown in dotted outline) received within a correspondingly shaped bore within the platform 10a, the plunger rods 48, 49 having at their ends respective drive pins 50, 51 which extend into and engage with the inner walls of these spiral slots 46, 47 such that rotation of the disc 45 anticlockwise in the direction arrowed forces the plungers 48, 49 and hence the moveable clamp jaws 13b, 14b outwards in opposite directions towards respective fixed clamp jaws 11b and 12b at which position it will be understood that due to the length of the slots 46, 47 there is sufficient frictional resistance in the system to ensure that a length of floss 3a can be trapped therebetween until the disc 45 is rotated in the clockwise direction to release the plungers 48, 49 and hence moveable clamp jaws 13b, 14b.

It will be seen that the third embodiment of the invention has relatively few moving parts which may also be relatively robust and easy to clean, as well as being relatively simply to manufacture, whether it be incorporated as part of a flosser attachment for a toothbrush driver or as part of a flosser which incorporates its own motor and drive mechanism.

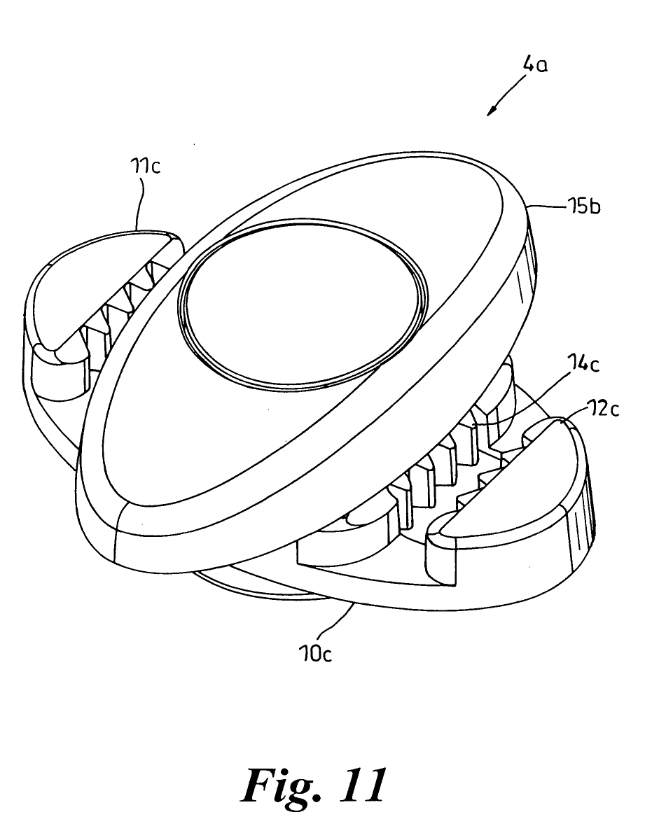

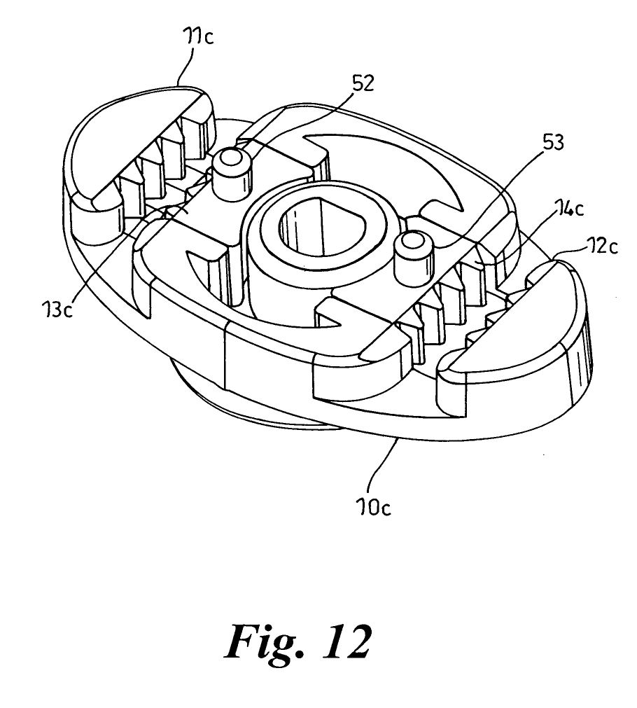

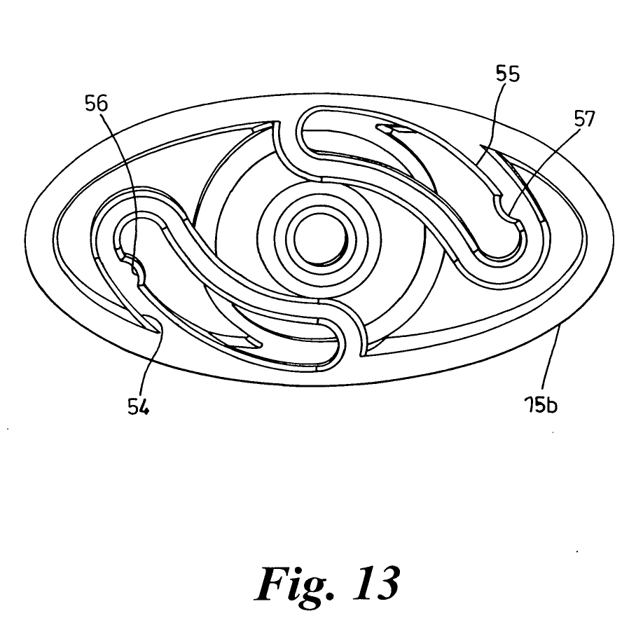

In a still further embodiment of the invention shown with reference to FIGS. 11 to 13 the moveably mounted platform 10c again includes fixed clamp jaws 11c, 12c and slideable clamp jaws 13c, 14c (shown more clearly in FIG. 12), the slideable clamp jaws 13c, 14c, each having respective drive pins 52, 53 extending upwardly therefrom and being engageable in respective arcuate slots 54, 55 on the underside of a rotatable knob 15b as shown in FIG. 13. The slots 54, 55 act as cam surfaces which bear against the drive pins 52, 53 when the knob 15b is rotated to the limit imposed by a respective pair of detents 56, 57 in the slots 54, 55 such that in the position shown in FIG. 11 the clamp mechanism shown generally at 4a is open and upon rotation through 90 degrees of the knob shown 15b to a position cor^{r}esponding to the knob as shown in FIG. 2 the drive pins 52, 53 and hence slideable clamps 13c and 14c are forced to move outwardly with respect to each other to close the locking mechanism.

While all four embodiments of the invention thus far described are believed to offer novel and practical devices for dental flossing it will be understood that variations thereof may be possible without departing from the spirit and scope of the invention.

I claim:

1. A dental flosser attachment for a toothbrush driver in which dental floss from a spool on or in the attachment is fed via a floss quick release locking mechanism to a floss receiving end of one of a pair of prongs extending from the body of the attachment, to a floss receiving end of the other prong, and back to the quick release mechanism such that a free end of the floss may be pulled to tension the floss between the prongs, whereafter the quick release mechanism is releasably locked to retain the tension of the floss therebetween, including across the prongs, the quick release mechanism being mounted for reciprocable rotation relative to the prongs to thereby cause the floss to oscillate therebetween when the flosser attachment is activated by the toothbrush driver.

2. A dental flosser attachment according to claim 1 further characterized in that the dental flosser attachment is driven by a motor via a drive train in which circular motion is translated into oscillating or reciprocating movement.

3. A dental flosser attachment according to claim 2 further characterized: in that the drive train includes a crown gear and associated spur gear, to which crown gear is eccentrically mounted a drive pin attached to one end of a drive link, the other end of which is attached to at least one of the quick release mechanism and a platform on which the quick release mechanism is mounted.

4. A dental flosser attachment according to claim 1, 2 or 3 further characterized in that the quick release mechanism comprises a pair of fixed clamp jaws, against each of which a pair of slidable clamp jaws are engageable to trap respective parts of a length of floss therebetween, the intermediate length of floss being at least partially supported by the prongs of the flosser attachment to enable flossing by a user of the combination flosser attachment and toothbrush driver.

5. A dental flosser attachment according to claim 4 further characterized in that the slideably mounted clamp jaws have cam surfaces co-operable with projections on or in a rotatable knob adjacent thereto such that upon partial rotation of the knob in one direction the slideable jaws are forced apart so as to engage with the fixed clamp jaws or floss therebetween.

6. A dental flosser attachment according to claim 5 further characterized in that the slideable clamp jaws are biased to an open position by means of a spring arm.

7. A dental flosser attachment according to claim 6 further characterized in that the spring arm comprises two springs, one for each slideable clamp jaw.

8. A dental flosser attachment according to claim 7 further characterized in that the two springs are integrally formed with a centrally disposed collar relative to a rotational axis of the knob.

9. A dental flosser attachment according to claim 3 further characterized in that the slideably mounted clamp jaws are forced to their closure position against the fixed clamp jaws by means of an over-center cam locking arrangement including a relatable drive plate having diagonally opposite cam surfaces which engage innermost surfaces of the slideable clamp jaws such that upon rotation of the drive shaft in one direction the jaws forced apart to engage with the fixed clamp jaws or floss there between.

10. A dental flosser attachment according to claim 9 further characterized in that the drive link is attached to the drive plate to provide an over-center cam locking arrangement whereby the slideable clamp jaws are retained in their locked position when the drive plate is rotated slightly beyond a point by which the slideable clamp jaws are in an initially locked position, such that upon rotation of the drive plate in an opposite direction the slideable jaws become unlocked and can be returned to an original open position.

11. A dental flosser attachment according to claim 1, 2 or 3 further characterized in that the quick release mechanism is in the form of a slotted element in which a pair of symmetrically disposed spiral slot edges act as cam surfaces co-operable with projections, coupled to the slideable clamp jaws, such that upon rotation of the slotted element the slideable jaws move between open and closed positions relative to the fixed jaws.

12. An electrically powered flosser comprising a body portion, a head portion from which extend a pair of prongs for receiving floss therebetween, the head portion including a quick release mechanism for releaseably locking a length of floss between the prongs of the flosser, the quick release mechanism being mounted for reciprocable movement such that floss between the prongs oscillates on movement of the quick release mechanism when locked, the quick release mechanism being drivingly connected to a motor in the body portion.
